(19) United States
(12) Patent Application Publication
(10) Pub. No.: US 2022/0134456 A1
(43) Pub. Date: May 5, 2022

(54) CHAINSAW TOOTH SHARPENER APPARATUS AND METHOD OF SHARPENING THEREOF

(71) Applicant: Service mecanique PR Inc., Saint-Julien (CA)

(72) Inventor: Pierre Routhier, Saint-Julien (CA)

(21) Appl. No.: 17/515,790

(22) Filed: Nov. 1, 2021

Related U.S. Application Data
(60) Provisional application No. 63/109,504, filed on Nov. 4, 2020.

(51) Int. Cl. B23D 63/16

(52) U.S. Cl. CPC B23D 63/166

(57) ABSTRACT

A chainsaw tooth sharpening tool is presented with a first, e.g., planar, section for reducing a depth gauge of a tooth of the chain and a second section having a geometry for sharpening a cutting corner of the tooth. A chainsaw tooth sharpener apparatus using the chainsaw tooth sharpening tool is also presented. The apparatus comprises a motor for driving a rotative chainsaw tooth sharpening tool to be mounted thereto according to a rotation axis, a base to hold a tooth of a chain to be sharpened, and adjustment means to adjust the motor relative to the base. The adjustment means are adapted to adjust the motor relative to the base according to at least two of a) a depth adjustment, b) a longitudinal adjustment relative to the chainsaw tooth, and c) an angular adjustment relative to the chainsaw tooth.

### CROSS-REFERENCE TO RELATED APPLICATION

This U.S. Patent Application is a non-provisional of and claims priority from U.S. Provisional Patent Application No. 63/109,504 filed Nov. 4, 2020, the specification of which is hereby incorporated herein by reference in its entirety.

### FIELD OF THE INVENTION

The present invention generally relates to the field of saw sharpeners. Specifically, the present invention relates to a chainsaw sharpener apparatus and method of sharpening thereof.

### BACKGROUND OF THE INVENTION

Anyone who has tried to sharpen a chain of a chainsaw is aware it is a difficult and tedious task requiring a lot of practice and dexterity. A cylindrical sharpener is generally used to sharpen the teeth of the chain. An angle of about 30-degree, as example, must be maintained with respect to the chain. Other angles can be used depending of the material to be cut. A slight upward angle is also required before moving the sharpener in a reciprocating manner for sharpening each tooth. The chain is not fixedly maintained in the guide bar which increases the level of complexity for sharpening the teeth of the chain. The required sharpener position must be maintained throughout the sharpening of each tooth. Furthermore, the transversal direction of adjacent tooth is alternating on each transversal side of the bar, which requires to change the work arrangement to position the sharpener in the proper direction.

Each tooth is preceded with a depth gauge to limit the depth at which the tooth is going to work in the wood. Each tooth is positioned with a slight longitudinal slope so that, when a tooth in sharpened and some material is removed therefrom, the height of the tooth is diminishing. The depth gauge has to be lowered consequently to maintain an optimal cutting depth for each tooth. This means that a second step is required in addition to sharpening each tooth, which increases the time and the complexity of sharpening correctly a chainsaw tooth. This is why sharpening a chainsaw is not given to most.

Some tools are available to sharpen a chainsaw tooth, but they are generally complicated to use, not providing a decent result and are often requiring as much time as doing the work manually as explained above.

Therefore, a need has been felt in the field of chainsaw sharpening that is easy to use. It is desirable that the tool tangibly improves the quality and the speed of sharpening the chainsaw. Furthermore, it is also desirable that the sharpening tool be inexpensive and portable. Other needs can be appreciated by anyone who already tried to sharpen a chainsaw or has bought a sharpening widget that is not fulfilling the promises of the sale person.

### SUMMARY OF THE INVENTION

The present invention includes many aspects and features. The aforesaid and other objectives of the present invention are realized by generally providing a chainsaw sharpener apparatus and method of sharpening thereof.

The invention generally relates to a chainsaw sharpener that is secured to the bar of a chainsaw and that is allowing a plurality of adjustments for locating a sharpening tool at proper locations for sharpening each tooth with a translation where the sharpening tool is simultaneously sharpening the tooth and lowering the depth gauge associated therewith.

At least one aspect of the present invention provides a chainsaw sharpener apparatus including a single sharpening tool for sharpening a tooth and its depth gauge at once, in accordance with at least one embodiment.

At least one aspect of the present invention provides a chainsaw sharpener apparatus including a bar-securing mechanism and a tooth-securing mechanism to ensure optimal positioning and holding of the tooth to be sharpened, in accordance with at least one embodiment.

At least one aspect of the present invention provides a chainsaw sharpener apparatus including a first adjustment mechanism adapted to set a vertical reference (Z-axis [knob 1]) above the bar, a second adjustment mechanism adapted to clamp and localize the chainsaw sharpener to the bar (X-axis and Y-axis [knobs 2]), an angular adjustment [knob 3] for setting an angle about the bar to transversally reciprocate the sharpening tool with respect to the tooth and associated depth gauge, a sharpening tool height adjustment and a tooth-securing mechanism [knob 4] securing the tooth with respect to the chainsaw sharpener hence preventing any relative movement of the tooth when sharpening the tooth.

At least one aspect of the present invention provides a sharpening tool for sharpening a tooth and its depth gauge at once, the sharpening tool having a shape adapted to reach both the tooth and the depth gauge in accordance with at least one embodiment.

At least one aspect of the present invention provides an abrasive coated form wheel sharpening tool for sharpening a tooth and its depth gauge in accordance with at least one embodiment.

The features of the present invention which are believed to be novel are set forth with particularity in the appended claims. Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other objects, features and advantages of the invention will become more readily apparent from the following description, reference being made to the accompanying drawings in which:

FIG. 1 is showing a perspective view of a chainsaw sharpener apparatus in accordance with principles and embodiments of the present invention;

FIG. 2 is showing a left side elevation view of a chainsaw sharpener apparatus in accordance with principles and embodiments of the present invention;

FIG. 3 is showing a perspective view of a chainsaw sharpener apparatus in accordance with principles and embodiments of the present invention;

FIG. 4 is showing a right elevation view of the chainsaw sharpener apparatus in accordance with principles and embodiments of the present invention;

FIG. 5 is showing a front elevational view of a chainsaw sharpener apparatus in accordance with principles and embodiments of the present invention;

FIG. 6 is showing a bottom plan view of a chainsaw sharpener apparatus in accordance with principles and embodiments of the present invention;

FIG. 7 is showing a perspective view of a chainsaw sharpener apparatus in accordance with principles and embodiments of the present invention;

FIG. 8 is showing a back-elevation view of a chainsaw sharpener apparatus in accordance with principles and embodiments of the present invention;

FIG. 9 is showing a perspective view of a chainsaw sharpener apparatus in accordance with principles and embodiments of the present invention;

FIG. 10 is showing a perspective view of a chainsaw sharpener apparatus in accordance with principles and embodiments of the present invention;

FIG. 11 is showing a top plan view of a chainsaw sharpener apparatus in accordance with principles and embodiments of the present invention;

FIG. 12 is showing a perspective view of a portion of a chainsaw sharpener apparatus in accordance with principles and embodiments of the present invention;

FIG. 13 is showing a side elevation view of chainsaw tooth in accordance with principles and embodiments of the present invention;

FIG. 14 is showing a top view of a chainsaw tooth in accordance with principles and embodiments of the present invention;

FIG. 15 is showing a sectional right elevational view of a chainsaw sharpener apparatus in accordance with principles and embodiments of the present invention;

FIG. 16 is showing an exploded isometric view of a chainsaw sharpener apparatus in accordance with principles and embodiments of the present invention;

FIG. 17 is showing an isometric view of a reference lever accordance with principles and embodiments of the present invention;

FIG. 18 is showing a left elevation view of a reference lever accordance with principles and embodiments of the present invention;

FIG. 19 is showing a partial section view of a reference lever and sharpening tool in accordance with principles and embodiments of the present invention;

FIG. 20 is showing a partial isometric view of a reference lever and sharpening tool in accordance with principles and embodiments of the present invention;

FIG. 21 is showing a top plan view of a sharpening tool in accordance with principles and embodiments of the present invention;

FIG. 22 is showing an isometric view of a sharpening tool in accordance with principles and embodiments of the present invention;

FIG. 23 is showing a side elevation view of a sharpening tool in accordance with principles and embodiments of the present invention;

FIG. 24 is showing a side elevation view of a sharpening tool in accordance with principles and embodiments of the present invention; and

FIG. 25 is showing a side elevation section view of a sharpening tool in accordance with principles and embodiments of the present invention.

### DETAILED DESCRIPTION

As a preliminary matter, it will be understood by one having ordinary skill in the relevant art (“Ordinary Artisan”) that the invention has broad utility and application. Furthermore, any embodiment discussed and identified as being “preferred” is Considered to be part of a best mode contemplated for carrying out the invention. Other embodiments also may be discussed for additional illustrative purposes in providing a full and enabling disclosure of the invention. Furthermore, an embodiment of the invention may incorporate only one or a plurality of the aspects of the invention discloses herein; only one or a plurality of the features disclosed herein; or combination thereof. As such, many embodiments are implicitly disclosing herein and fall within the scope of what is regarded as the invention.

Accordingly, while the invention is described herein in detail in relation to one or more embodiments, it is to be understood that this disclosure is illustrative and exemplary of the invention and is made merely for purposes of providing a full and enabling disclosure of the invention. The detailed disclosure herein of one or more embodiments is not intended, nor is to be construed, to limit the scope of patent protection afforded the invention in any claim of a patent issuing here from, which scope is to be defined by the claims and the equivalents thereof. II is not intended that the scope of patent protection afforded the invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the invention. Accordingly, it is intended that the scope of patent protection afforded the invention is to be defined by the issued claim(s) rather than the description set forth herein.

Additionally, it is important to note that each term used herein to that which the Ordinary Artisan would understand such term to mean bases on the contextual use of such term herein. To the extent that the meaning of a term used herein-as understood by the Ordinary Artisan based on the contextual use of such term-differs in any way from any particular dictionary definition of such term, it is intended that the meaning of the term as understood by the Ordinary Artisan should prevail.

With regard solely to construction of any claim with respect to the United States, no claim element is to be interpreted under 35 U.S.C. 112(f) unless the explicit phrase “means for” or “step for” is actually used in such claim element, whereupon this statutory Provision is intended to and should apply in the interpretation of such claim element. with regard to any method claim including a condition precedent step, such method requires the condition precedent to be met and the step to be performed at least once during performance of the claimed method.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers.” “a picnic basket having crackers without cheese”, and “a picnic basket having both cheese and crackers.” When used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”.

Referring the drawings, one or more preferred embodiments of the invention are next described. The following description of one or more preferred embodiments is merely exemplary in nature and is in no way intended to limit the invention, its Implementations, or uses. Hence, a novel ribbed aerodynamic skirt in accordance with principles and embodiments of the present invention will be described herein after.

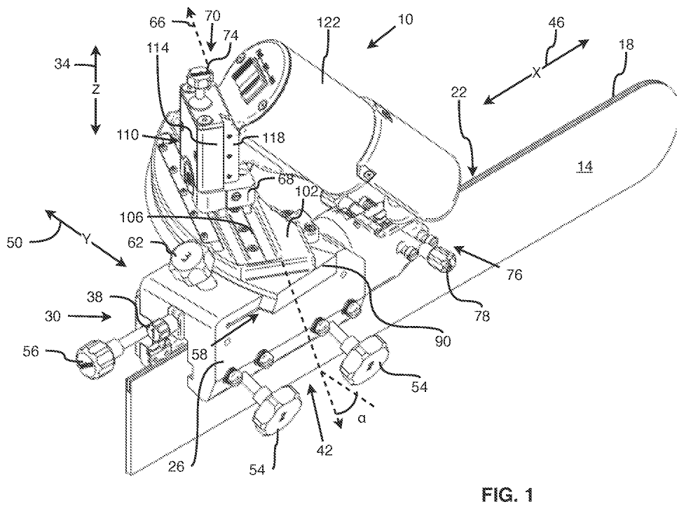

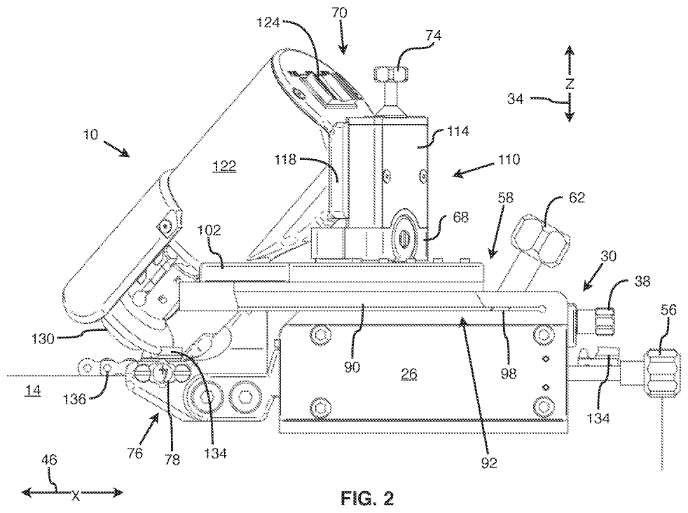

In respect with embodiments thereof, a chainsaw sharpener apparatus 10 is illustrated in FIG. 1. The chainsaw sharpener apparatus 10 is sized and designed to be secured to a guide bar 14 of a chainsaw sized and designed for precisely locating the chain 136 (illustrated in FIG. 2) with respect to the chainsaw sharpener apparatus 10. The guide bar 14 is locating and supporting the chain 136 with a guide 18 having a recessed portion 22 therein for engaging the chain 136.

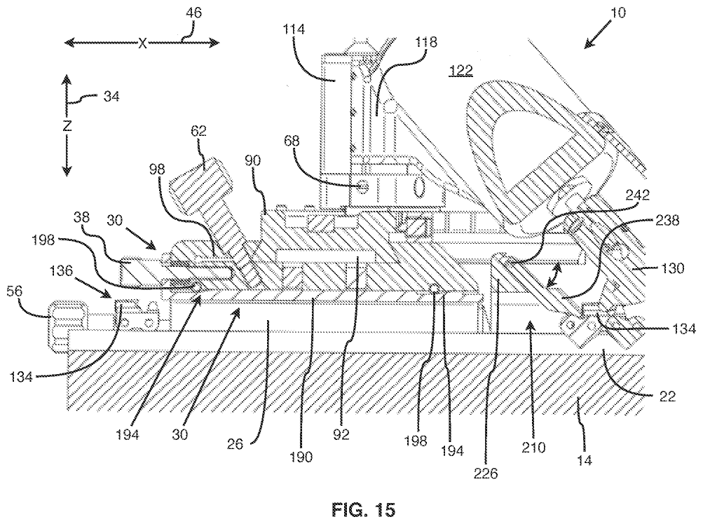

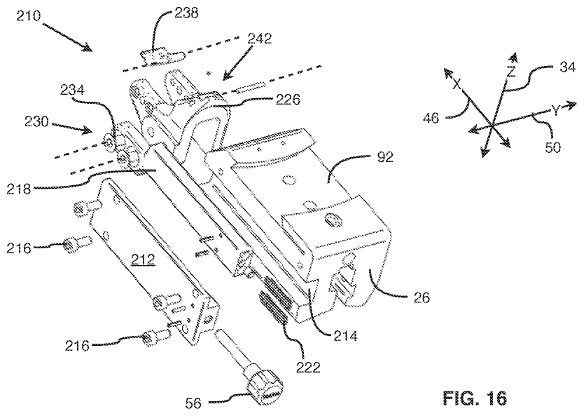

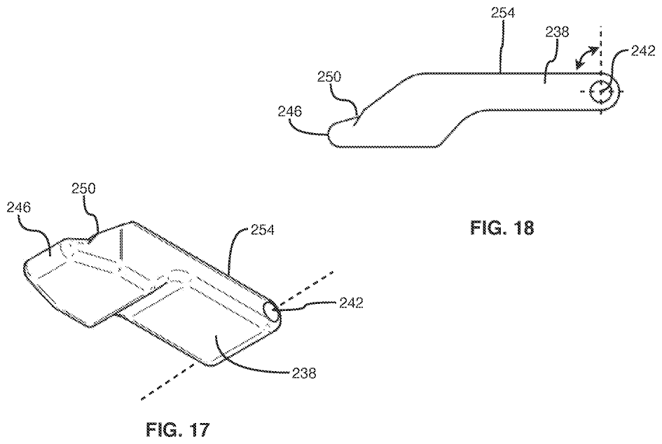

The chainsaw sharpener apparatus 10 is including a support 26 adapted to secure the chainsaw sharpener apparatus 10 to the guide bar 14 of the chain 136. The support 26 is including a first adjustment mechanism 30 adapted to set a vertical reference position along a Z-axis 34 with respect to the uppermost portion of the chain 136. The vertical reference position can be set using knob #1, identified with reference identification 38, and serves as a basis for vertical adjustments of the chainsaw sharpener apparatus 10. Further details about the vertical reference position will be provided below in the description with reference to FIG. 16 while we first continue to describe the various fundamental adjustments of the chainsaw sharpener 10. A clamping mechanism 42 is adapted to localize and secure the chainsaw sharpener apparatus 10 to the guide bar 14 to set a reference along an X-axis 46 and a Y-axis 50. The clamping mechanism 42 can be set using the pair of knobs #2, identified with reference identification 54, to firmly secure the support 26 to the guide bar 14 in both the X-axis 46 and the Y-axis 50. A cutting length adjustment mechanism 210 in the X-axis, best illustrated in FIG. 17, is actuated and set with knob 56 that is used to define a distance between a reference lever 238 and a sharpening tool 130 to set a depth of the sharpening in the cutting corner 156 of the tooth 134 (not seen in FIG. 1) along the X-axis 46. This cutting length adjustment mechanism 210 is going to be discussed below in further details with reference to FIG. 15 and FIG. 16. A third adjustment mechanism 58 can be set with knob #3, identified with reference identification 62, for setting an angle α about the guide bar 14 to transversally reciprocate 66 a carriage 68 of the chainsaw sharpener apparatus 10 with respect to the guide bar 14 in the desired angle to correctly sharpen the tooth 134. A sharpening tool height adjustment 70, along the Z-axis, can be set with knob 74.

It is desirable to maintain and secure the tooth 134 that is going to be sharpened to prevent undesirable movements that could alter the precise sharpening angle of the tooth 134. A tooth-securing mechanism 76 is provided to laterally secure the tooth 134 to be sharpened using knob #4, identified with reference identification 78, for securing the tooth 134 (not visible in FIG. 1) with respect to the chainsaw sharpener apparatus 10. This is preventing any relative movements of the tooth 134 when sharpening the tooth 134 with the chainsaw sharpener apparatus 10.

The chainsaw sharpener apparatus 10 is also including a semi-circular plate, also referred to as segment plate 90 engaged in a cooperating recess portion 92 defined in the support 26. The segment plate 90 can pivot in the recess portion 92 to set a desired transversal top plate angle α that generally ranges between 10-degree to 35-degree angle depending of the outside top plate angle of the tooth 134. Pre-set positions 94 are defined with predetermined angles α and are selectively located with a biasing mechanism like a spring-loaded plunger (not illustrated) offering a selective restriction at these angles when changing the angle of the segment plate 90 to make sure of the angle precision. The recess portion 92 in the support 26 includes a slot 98 that can be compressed with the knob #3, 62, to block the semi-circular plate 90 at a desired angle.

A translational support 102 is secured to the segment plate 90 to allow the required translational and reciprocating movement of the sharpening tool 130 when sharpening the teeth 134. The translational support 102 is held in place with fasteners and is including a bearing mechanism 106 providing a smooth and precise translation. The carriage 68 is slidably secured to the translational support 102 with the bearing mechanism 106 for allowing back and forth translation of the motor support 110. The motor support 110 includes two main cooperating parts, a vertical mount 114 and a motor adaptor 118 configured to slide one on the other to provide the height adjustment 70 of the motor 122 and the sharpening tool 130 via knob 74. The motor 122, equipped with a forward/off/reverse switch 124, is secured at an angle to the motor adaptor 118 in an operating configuration. A protection guard 126 is optionally secured to the motor 122 for protecting a user from particles that could be produced when sharpening the chain.

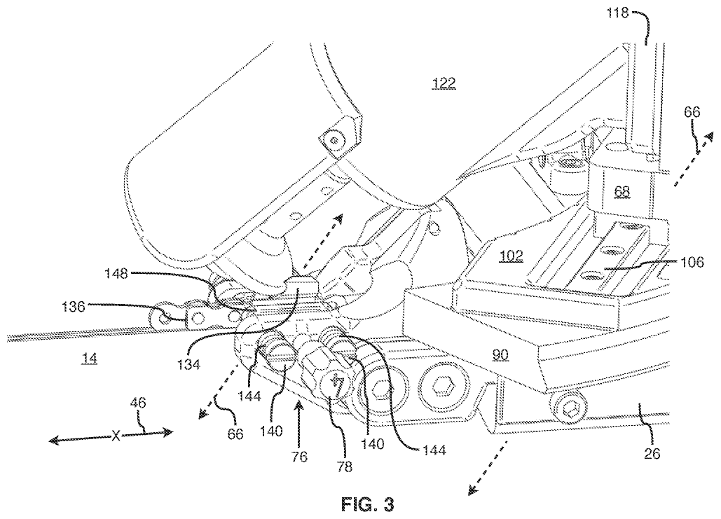

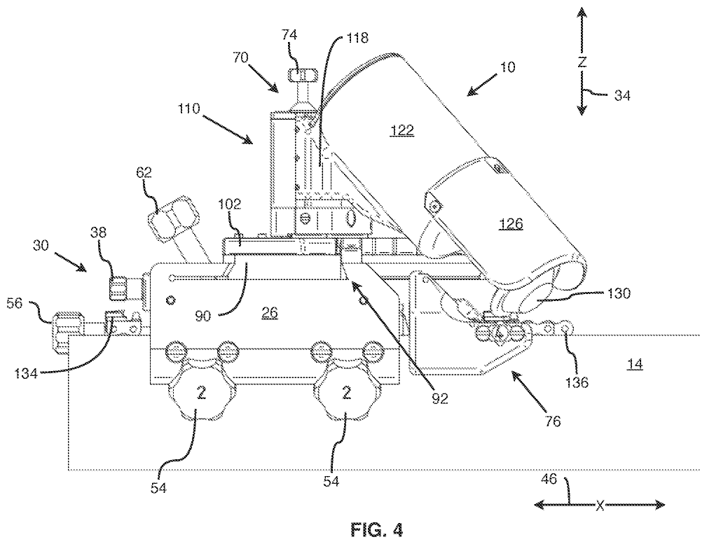

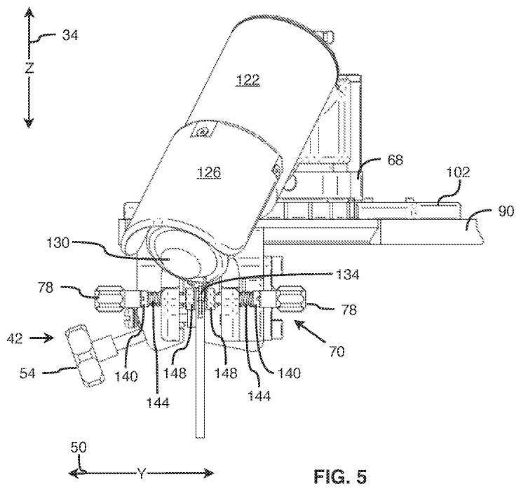

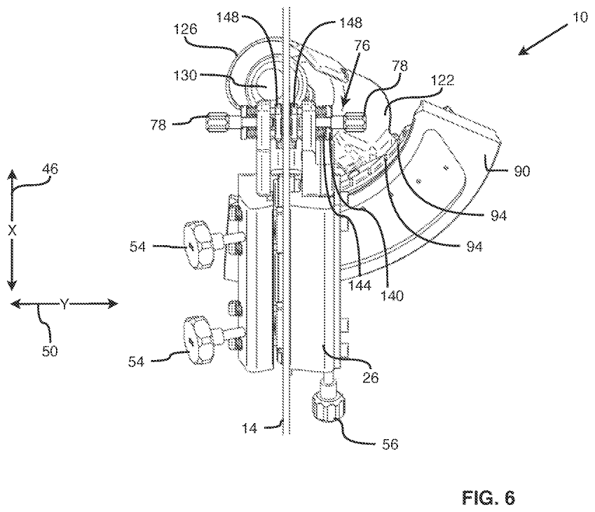

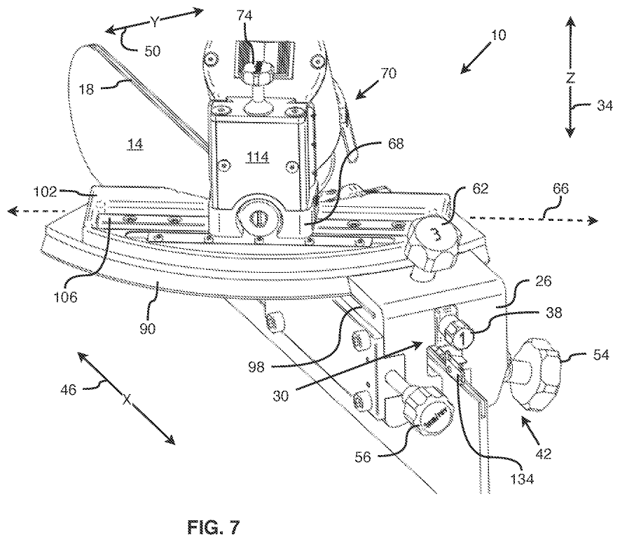

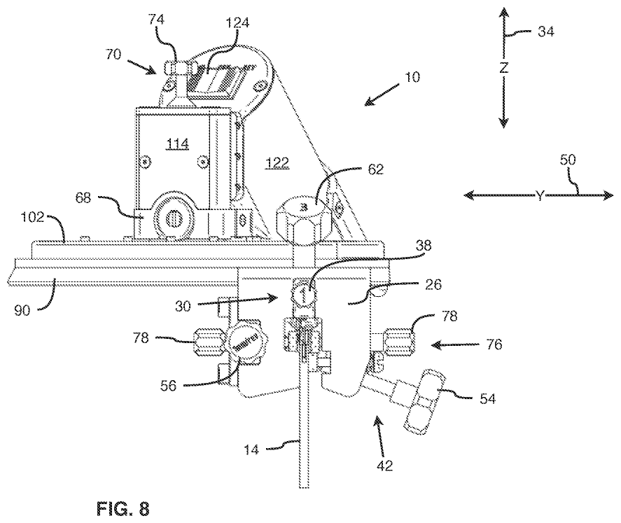

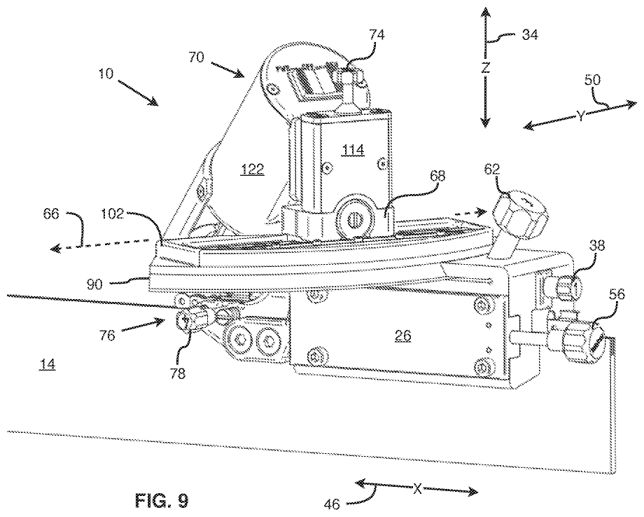

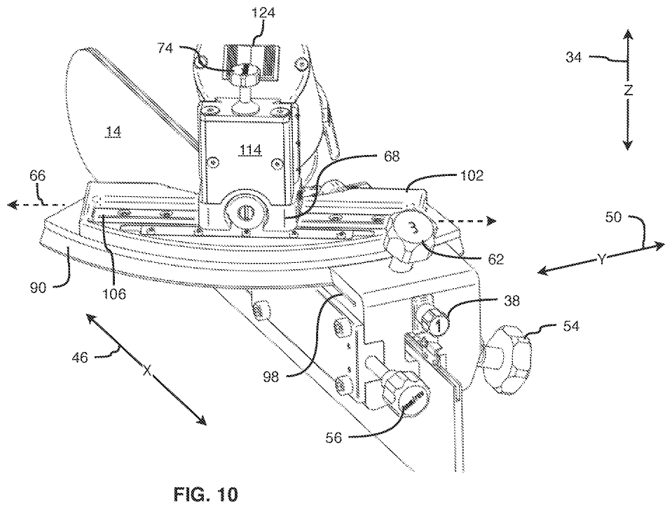

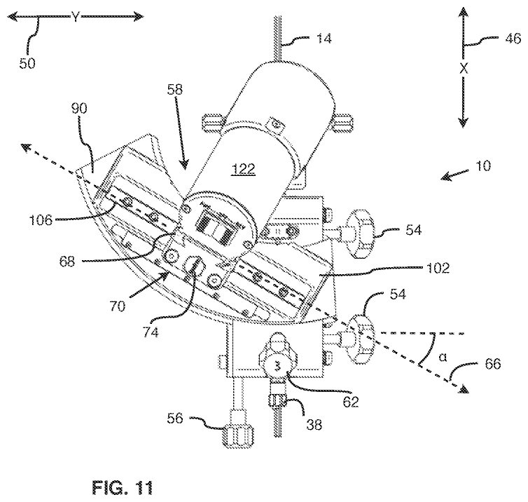

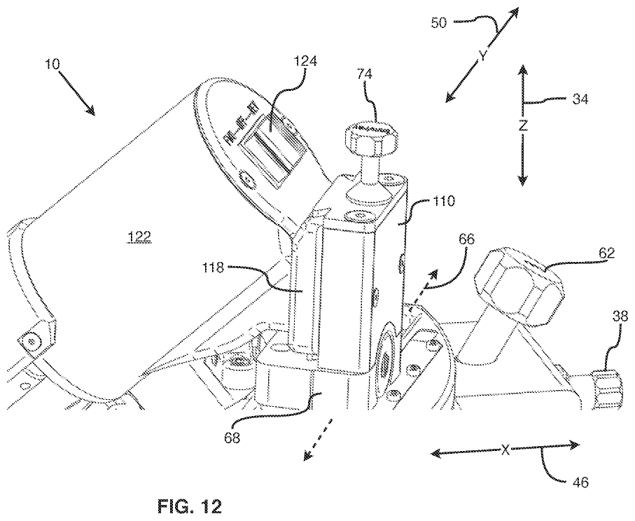

Moving now to FIG. 2 throughout FIG. 5 where one can appreciate the motor 122 is equipped with the sharpening tool 130 illustratively engaged with a tooth 134. The design of the sharpening tool 130 is going to be detailed later in the description since it is not possible to have a sufficient level of details in these figures. However, the tooth-securing mechanism 76 is magnified in FIG. 3, FIG. 5 and FIG. 6, where a pair of adjustment screws 140 are used in combination with compression springs 144 to preload a guide plate 148 toward the tooth 134 to center the tooth 134 in a desirable alignment with the sharpening tool 130. Once the alignment is done between the guide plates 148 of the tooth-securing mechanism 76 disposed on respective sides of the tooth 134, the knob #4, 78 can be tightened to secure the tooth 134 in place and sharpen it with the sharpening tool 130. Additional details of the chainsaw sharpener apparatus 10 can be appreciated in FIG. 6 throughout FIG. 12.

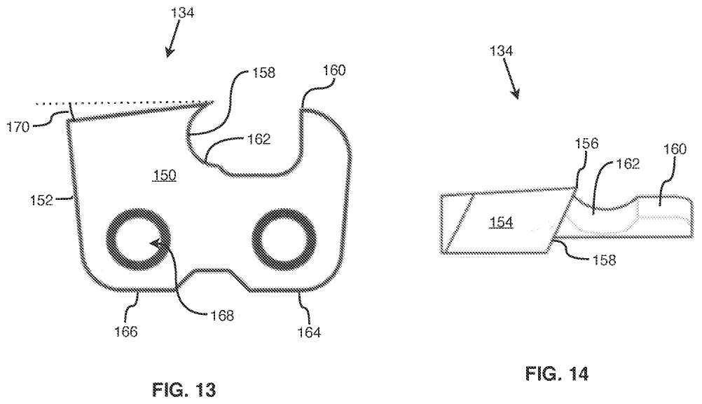

For further precision, it is desirable to define the terms used with respect to a chainsaw tooth 134 for the following sections of the description. With reference to FIG. 13 and FIG. 14, various portions of a tooth 134 can be appreciated. Namely, a top plate 154, a cutting corner 156, a side plate 158, a depth gauge 160, a gullet 162, a toe 164, a heel 166, a rivet hole 168, and a clearance angle 170. The tooth 134 comprises a body 150 and a rear 152 according to normal advancement of the tooth 134.

Moving now to FIG. 15 illustrating a section view of the chainsaw sharpener apparatus 10 to better illustrate the first adjustment mechanism 30 that was briefly discussed above in the description. As we have explained, the first adjustment mechanism 30 is used to set a vertical reference along the Z-axis 34. This reference is taken between a contact member 190 inside the support 26 configured to rest on top of the chain 136, contacting the uppermost portion of the teeth 134, to set a relative height of the support 26 for further calibrations and operations. The contact member 190 is operatively connected to the knob #1, 38, to move along the X-axis 46, for providing some height adjustment with the interaction between a pair of angled portions 194 and cooperating bearing members 198. One can appreciate the contact member 190 is biased toward the knob #1, 38, for moving along the X-axis 46 in both directions upon screwing or unscrewing of knob #1, 38. Actuation of the knob #1, 38 is longitudinally moving the contact member 190 along the X-axis 46 hence changing the vertical distance between the contact member 190 and the support 26.

Still with reference to FIG. 15, it can be appreciated that the knob #3, 62, is engaging its threads in a lower portion of the support 26 to compress the slot 98 when tighten, hence secure the segment plate 90 in place. Additionally, a portion of the cutting length adjustment mechanism 210 is visible on FIG. 15 while the complete mechanism can be appreciated in FIG. 16. The cutting length adjustment mechanism 210 is required to set a longitudinal distance along the X-axis 46 between a tooth 134 to sharp and the sharpening tool 130. The longitudinal distance between the tooth 134 and the sharpening tool 130 is important because this is how is set the depth in the X-axis 46 of the cut made by the sharpening tool 130 in the tooth 134 to sharpen the cutting portion of the tooth 134. This longitudinal distance along the X-axis 46 between the tooth 134 and the sharpening tool 130 is set with a rotation of knob 56 that is offering a precision of one millimeter per rotation, as embodied in the illustrated embodiment. The knob 56 is engaged in and maintained by a side cover 212 that is secured to the support 26 to cover a cavity 214 extending along the X-axis 46 with a series of fasteners 216. The knob 56 is screwed in a translational member 218 slidably engaged in the cavity 214. The knob 56 is not moving along the X-axis 46 when actuated but axially moves the translational member 218 inside the cavity 214. A biasing mechanism embodied as a pair of springs 220 is providing the tension to pull back the translational member 218 when unscrewing the knob 56. Therefore, rotation of the knob 56 is going to produce a relative motion between the translational member 218 and the support 26 to move chariot 226 disposed in front of the support 26, as illustrated in FIG. 16. The translational member 218 is connecting the chariot 226 with a lateral connection 230 using a pair of bolts 234, or an analogous fastening system.

The chariot 226 and its interaction with the tooth 134 can be appreciated in FIG. 15. Indeed, the chariot 226 is pivotably connected to a reference lever 238 that is pivotably secured to the chariot 226 via a pivot 242. The reference lever 238 is adapted to contact and block the tooth 134 to be sharpen in a first direction, along the X-axis 46, toward the support 26. The reference lever 238 is also configured to pivot and allow a change in tooth 134 when the chain 136 is translated in the opposite direction, so that a user can easily change the tooth 134 to be sharpened when a previous one is sharpened. Note that the side of the cutting portion of the tooth 134 is typically alternated in a chain 136 of a chainsaw and that it might be convenient to jump every other tooth 134 and work all the teeth 134 that are on the same side instead of changing the angle of the segment plate 90. It can be seen in FIG. 15 the distance of the chariot 226 and the reference lever 238 with respect to the location of the sharpening tool 130 will be decided by the adjustment of the knob 56 while the motor 122 and the sharpening tool 130 are going to remain fixed with respect to the support 26. One can appreciate that the adjustment of the cutting length adjustment mechanism 210 is made when the sharpening tool 130 is not directly aligned with a tooth 134 because there would likely be interferences therebetween. The sharpening tool 130 is normally rotating when the user is translating the carriage 68 to sharpen the tooth 134 when the sharpening tool 130 is intersecting the tooth 134 along its trajectory.

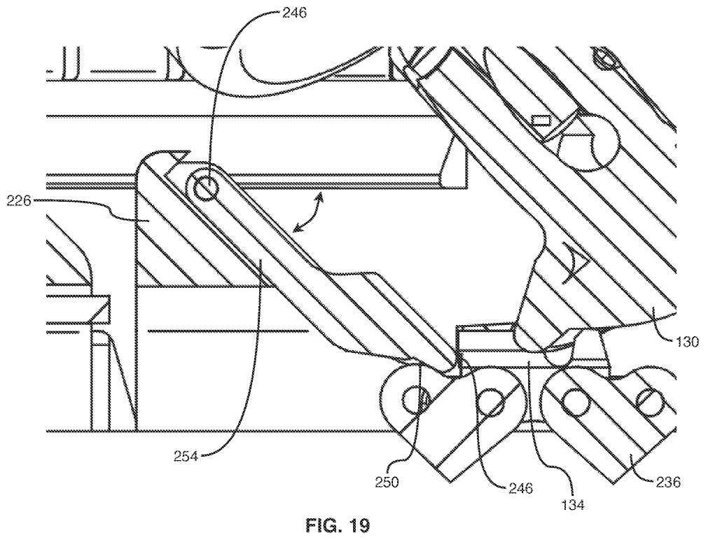

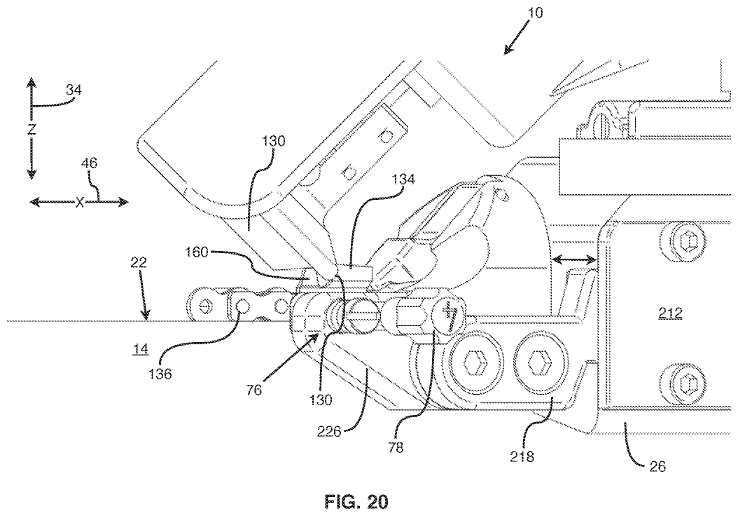

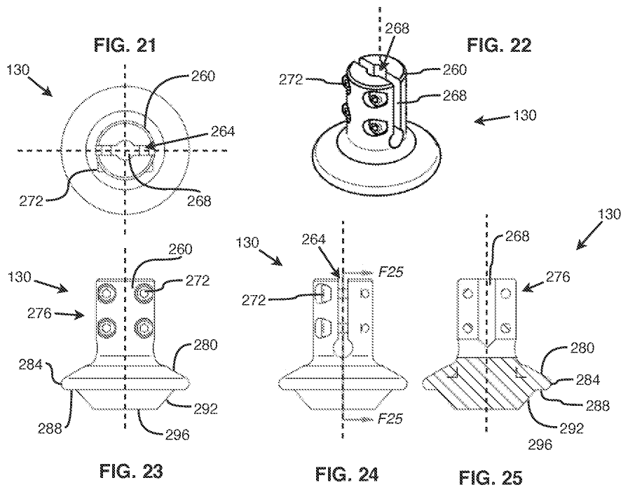

The reference lever 238 is magnified in FIG. 17 and FIG. 18. The reference lever 238 is generally made of strong material preventing undesired deformation with repetitive contacts with the tooth 134. Steel can be a suitable material. Preferably, hardened steel or a combination of steel and tungsten carbide should be used for durability. The reference lever 238 includes a tooth-contacting portion 246, a chain-contacting portion 250 and a chariot-contacting portion 254. The tooth-contacting portion 246 is narrower to fit in the reduced space next to the tooth 134. The tooth-contacting portion 246 and the chain-contacting portion 250 are disposed adjacent one another to properly fit next to the tooth 134 as best illustrated in FIG. 19. It is possible to also appreciate the interaction between the sharpening tool 130 and the tooth 134 in FIG. 19 and FIG. 20. The tooth 134 includes the cutting corner 156 and the depth gauge 160 that are respectively sharpened and lowered simultaneously with the sharpening tool 130. The sharpening tool 130 is designed with a shape allowing both actions as best seen in FIG. 2 throughout FIG. 25. The sharpening tool 130 comprises a shank 260 with a groove 264, a central opening 268 and a series of fasteners 272 for securing a rotation axle of the motor 122 in the central opening 268. The following dimensions are representing the illustrated embodiment although the precise dimensions and shape of the sharpening tool including a locking mechanism can vary to adjust to different types and sized of chain 136 without departing from the scope of the present invention. The shank 260 has a diameter of about 19 millimeters and a length 276 of about 28 millimeters, the groove 264 has a width of about 2 millimeters and an inside diameter of about 6.35 millimeters. The shank 260 is widening with an angle 280 of about 30-degrees into a radius 284 of about 2 millimeter, depending of the type of tooth to continue with a planar section 288 that is further restricting in diameter with a frustoconical shape 292 at an angle of 48-degrees to finish with a flat end 296 of about 20.32 millimeters. The sharpening tool 130 is preferably made of steel that is covered with an abrasive material like cubic boron nitride (CBN) of a desired grit or other plated/bonded deposited abrasive. The external shape of the sharpening tool 130 is allowing simultaneous sharpening of the cutting corner 156 and the depth gauge 160 that is resulting in a perfect cut with a single translation movement of the carriage 68 and the motor 122 secured thereon.

While illustrative and presently preferred embodiment(s) of the invention have been described in detail hereinabove, it is to be understood that the inventive concepts may be otherwise variously embodied and employed and that the appended claims are Intended to be construed to include such variations except insofar as limited by the prior Art.

What is claimed is:

1. A chainsaw tooth sharpening tool comprising:
a first section for lowering a depth gauge of a chainsaw tooth of a chain; and
a second section for sharpening a cutting corner of the chainsaw tooth in conjunction with the first section.

2. The chainsaw tooth sharpening tool of claim 1, wherein at least one of the first section and the section second section has a curved profile.

3. The chainsaw tooth sharpening tool of claim 1, wherein at least one of the first section and the second section has a planar profile.

4. The chainsaw tooth sharpening tool of claim 1, further comprising a third section for lowering a close side of the depth gauge.

5. The chainsaw tooth sharpening tool of claim 1, being a rotative tool.

6. The chainsaw tooth sharpening tool of claim 1, wherein the first section and the second section are at least one of coated with an abrasive material, and made of an abrasive material.

7. The chainsaw tooth sharpening tool of claim 1, comprising a securing end distal from the first section and the second section.

8. The chainsaw tooth sharpening tool of claim 7, wherein the first section has a frustoconical shape having an apex-proximal face opposed to the securing end.

9. The chainsaw tooth sharpening tool of claim 1, wherein the second section has an apex, the first section has a tooth abutting portion, and wherein profile of the chainsaw tooth sharpening tool presents clearance relative to a line joining the apex to the tooth abutting portion.

10. A chainsaw tooth sharpener apparatus, comprising:
a motor for driving a rotative chainsaw tooth sharpening tool to be mounted thereto according to a rotation axis,
a base to hold a tooth of a chain to be sharpened, and
adjustment means to adjust the motor relative to the base,
wherein the adjustment means are adapted to adjust the motor relative to the base according to at least two of a) a depth adjustment, b) a longitudinal adjustment relative to the chainsaw tooth, and c) an angular adjustment relative to the chainsaw tooth.

11. The chainsaw tooth sharpener apparatus of claim 10, further comprising a support holding the tooth during a sharpening operation of the chainsaw tooth using the chainsaw tooth sharpener apparatus.

12. The chainsaw tooth sharpener apparatus of claim 10, wherein the chainsaw tooth comprises a body, and wherein the angular adjustment is of the rotation axis relative to a plane parallel to the body of the chainsaw tooth.

13. The chainsaw tooth sharpener apparatus of claim 10, further comprising a translational support, with the rotative motor being movable along the translational support.

14. The chainsaw tooth sharpener apparatus of claim 10, wherein the chainsaw tooth comprises a rear, and wherein the chainsaw tooth sharpener apparatus comprises a reference level for abutting the rear of the chainsaw tooth.

15. The chainsaw tooth sharpener apparatus of claim 14, wherein the reference level is rotatively mounted to the base.

16. The chainsaw tooth sharpener apparatus of claim 10, further comprising the chainsaw tooth sharpening tool.

17. The chainsaw tooth sharpener apparatus of claim 16, wherein the chainsaw tooth sharpening tool comprises a first section for lowering a depth gauge of the chainsaw tooth; and
a second section for sharpening a cutting corner of the tooth in conjunction with the first section.

18. The chainsaw tooth sharpener apparatus of claim 17, wherein at least one of the first section and the second section of the chainsaw tooth sharpening tool has a curved profile.

19. The chainsaw tooth sharpener apparatus of claim 17, wherein the first section and the second section of the chainsaw tooth sharpening tool are at least one of coated with an abrasive material, and made of an abrasive material.

20. The chainsaw tooth sharpener apparatus of claim 17, wherein the second section has an apex, the first section has a tooth abutting portion, and wherein profile of the chainsaw tooth sharpening tool presents clearance relative to a line joining the apex to the tooth abutting portion.
